(19) United States
(12) Patent Application Publication
(10) Pub. No.: US 2026/0005958 A1
(43) Pub. Date: Jan. 1, 2026

(54) Memory with Custom Memory Profile for Network Traffic Matching

(71) Applicant: Arista Networks, Inc., Santa Clara, CA (US)

(72) Inventors: Vishrant Nitin Vasavada, Fremont, CA (US); Srikanthaiah Hiremath, Sunnyvale, CA (US); Wilson Ng, Dublin, CA (US); Ryan Stacey Izard, Seneca, SC (US); Kiran Poola, Lathrop, CA (US); Animesh Patcha, Milpitas, CA (US); Christian Geddings Barrineau, Campbell, CA (US); Jianfu Chen, Richmond Hill (CA); Nishant Ranjan, San Jose, CA (US)

(21) Appl. No.: 18/755,585

(22) Filed: Jun. 26, 2024

(51) Int. Cl. H04L 45/74; H04L 45/00

(52) U.S. Cl. CPC H04L 45/74; H04L 45/38

(57) ABSTRACT

A network device may include memory circuitry such as a ternary content addressable memory (TCAM) for implementing a memory profile having qualifiers based on which flow entries are defined for network traffic matching. To facilitate the implementation of a custom memory profile on the TCAM, the controller may obtain support information for the TCAM, may obtain user configuration information indicative of a network policy, and may identify qualifiers for a memory profile customized based on the TCAM support information and the user configuration information. The network device may receive the identified qualifiers from the controller and configure the custom memory profile on the TCAM.

### BACKGROUND

A communications system includes network devices that are interconnected to form a network for conveying network traffic from source devices to destination devices. A network device can map network traffic to corresponding action(s) to be performed on the network traffic. In particular, memory such as ternary content addressable memory on the network device can store entries to which network traffic is matched. Depending on the entry to which network traffic is matched, action(s) corresponding to the entry may be performed for the matching network traffic.

### BRIEF DESCRIPTION OF THE DRAWINGS

FIG. 1 is a diagram of an illustrative networking system having one or more network devices coupled to a controller in accordance with some embodiments.

FIG. 2 is a diagram of an illustrative network device in accordance with some embodiments.

FIG. 3 is a diagram of an illustrative memory profile having a number of qualifiers for configuring memory circuitry in accordance with some embodiments.

FIG. 4 is a diagram of illustrative memory circuitry having flow entries for network traffic matching based on qualifiers of a memory profile in accordance with some embodiments.

FIG. 5 is a diagram of an illustrative controller configured to obtain support information about network device memory circuitry in accordance with some embodiments.

FIG. 6 is a diagram of illustrative supported qualifier information for network device memory circuitry in accordance with some embodiments.

FIG. 7 is a diagram of an illustrative controller configured to generate a memory profile customized based on user configuration information and memory support information in accordance with some embodiments.

FIG. 8 is a diagram of an illustrative customized memory profile obtained by a controller and conveyed to a network device to configure memory for storing flow entries in accordance with some embodiments.

FIG. 9 is a diagram of an illustrative controller configured to selectively generate memory profiles for different network devices based on the same user configuration information in accordance with some embodiments.

FIG. 10 is a flowchart of illustrative operations for configuring memory circuitry to store flow entries for network traffic matching in accordance with some embodiments.

### DETAILED DESCRIPTION

A network may include numerous interconnected network devices that process network traffic in a desired manner (e.g., based stored flow entries implementing one or more network policy rules). A network device may include memory circuitry such as one or more ternary content addressable memories (TCAMs) configured to store the flow entries each specifying a set of matching criteria to which corresponding header information of received network traffic is compared and matched and each specifying action(s) to be taken for matching network traffic. Each matching criterion may be matched to a value of a corresponding header field in the received network traffic. To specify the types of header fields to which entries in the memory circuitry are compared and matched, the memory circuitry may be configured with a memory profile specifying a set of qualifiers. The qualifiers of the memory profile define header field types for matching, and consequently, flow entries are constructed based on the set of qualifiers in the memory profile. Configurations in which memory profile qualifiers define traffic header fields are sometimes described herein as illustrative examples. In general, memory profile qualifiers may also define network device features such as Generic Routing Encapsulation (GRE) tunneling, Virtual Extensible Local Area Network (VXLAN) tunneling, VXLAN header stripping, etc., that share space with the traffic header fields within the memory profile.

Memory (e.g., a TCAM) that stores flow entries for network traffic matching may have a maximum size for the key space (e.g., a maximum total size for qualifiers). Accordingly, the memory profile for configuring the memory should contain qualifiers such that their collective size does not exceed this maximum size for the key space. Memory profiles having different sets of qualifiers are often predetermined and pre-stored on a network device and selected (based on a desired mode of operation) to configure the memory. However, this approach of using predetermined memory profiles may be non-scalable as numerous types of memory profiles would need to be stored and maintained, may require selection of a non-optimal memory profile to implement a set of network policy rules, and/or may otherwise be limiting.

To remove these limitations and/or impart other advantages, a system may facilitate the generation of a custom memory profile that includes a curated set of qualifiers specific to user configurations of policy rules. In illustrative configurations sometimes described herein as an example, a controller (e.g., implemented as part of a management server) may obtain information indicative of the capabilities of network device memory (e.g., the type and size of supported qualifiers, a total key space supported by the memory, etc.), may receive user configuration information (e.g., indicative of a network policy such as a traffic policy, an access control list policy, etc. and corresponding policy rules), and may generate a custom memory profile with a set of qualifiers (e.g., a subset of the supported qualifiers) that satisfies the requirement of the maximum size of the key space while being optimized for the desired network policy rules.

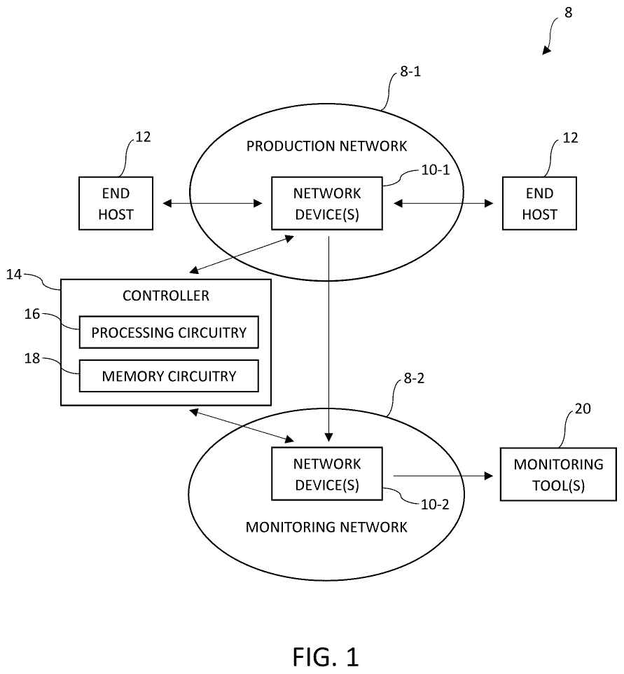

An illustrative networking system in which one or more network devices include memory circuitry configured with custom memory profiles is shown in FIG. 1. The description of custom memory profiles in connection with the system of FIG. 1 is merely illustrative. If desired, other systems and/or other network configurations may similarly employ the mechanisms described herein to obtain and use custom memory profiles.

In the example of FIG. 1, the networking system may include a communications network 8. Network 8 may be implemented to span a range of geographical locations or generally be implemented with any suitable scope. As examples, network 8 may include, be, or form part of one or more local segments, one or more local subnets, one or more local area networks (LANs), one or more campus area networks, a wide area network, etc. In some illustrative configurations described herein as an example, network 8 may include a data center network, a (software-defined) wide area network, and/or other networks. In general, network 8 may include one or more wired portions with network devices interconnected based on wired technologies or standards such as Ethernet (e.g., using copper cables and/or fiber optic cables) and, if desired, one or more wireless portions implemented by wireless network devices (e.g., to form wireless local area network (WLAN) or Wi-Fi networks). If desired, network 8 may include internet service provider networks (e.g., the Internet) or other public service provider networks, private service provider networks (e.g., multiprotocol label switching (MPLS) networks), and/or may include other types of networks such as telecommunication service provider networks.

In some illustrative configurations described herein, network 8 may include a production network such as production network 8-1 and a network traffic monitoring network such as monitoring network 8-2 communicatively coupled to production network 8-1. Monitoring network 8-2 may sometimes be referred to as analysis network 8-2, packet monitoring network 8-2, monitoring switch fabric 8-2, or monitoring fabric 8-2. Production network 8-1 may sometimes be referred to as forwarding network 8-1, production switch fabric 8-1, or production fabric 8-1. Production network 8-1 may, for example, be implemented locally (e.g., at a particular geographical location such as a school or college campus, a server or data farm, a building, a business campus, an airport, a hospital, or other locations) or may be distributed across multiple geographical locations. Monitoring network 8-2 may, for example, be implemented locally (e.g., at the same geographical location as part or all of production network 8-1), may be implemented at a different geographic location than production network 8-1 (e.g., may be remote from network 8-1), and/or may be distributed across multiple locations.

Production network 8-1 may include network devices 10-1 that forward network traffic (e.g., application data) between end hosts 12 of production network 8-1 implemented on corresponding host equipment. While not explicitly shown in FIG. 1, a network of network devices 10-1 may be interconnected with one another within network 8-1 via network paths (e.g., cables) coupled between corresponding ports of network devices 10-1. Edge network devices of devices 10-1 may have ports directly connected to host equipment via corresponding paths, while core network devices of devices 10-1 may have ports directly connected to ports of edge network devices and indirectly connected to host equipment through intervening (edge) network devices.

Traffic interception and mirroring mechanisms may be provided within production network 8-1 to convey production network traffic to monitoring network 8-2 for processing (e.g., monitoring). As a first example, a number of network tap devices (on and/or between network devices 10-1) may be included within production network 8-1. As a second example, mirroring or sampling functionalities with optional traffic filtering capabilities may be provided on some network devices 10-1 of production network 8-1. In general, these mechanisms on devices 10-1 or generally within network 8-1 may monitor and tap (e.g., mirror) traffic without interfering with normal production network traffic flow across network 8-1.

Monitoring network 8-2 may include network devices 10-2 that are controlled by a network controller 14 communicatively coupled to devices 10-2 via corresponding control paths (e.g., implemented over network paths in network 8-2). If desired, some of network devices 10-1 in production network 8-1 may also communicate with (e.g., be communicatively coupled to) and be managed (e.g., controlled) by controller 14. To provide the desired network behavior (e.g., implement a network policy), these network devices 10-1 and/or 10-2 may receive control and/or configuration data from network controller 14. If desired, different subsets of network devices 10-1 and/or 10-2 may be communicatively coupled to different computing equipment implementing controller 14 in a distributed manner.

While not explicitly shown in FIG. 1, a network of network devices 10-2 may be interconnected with one another within network 8-2 via network paths (e.g., cables) coupled between corresponding ports of network devices 10-2. In particular, network devices 10-2 may convey tapped network traffic from production network 8-1 along network paths in monitoring network 8-2 to one or more end hosts such as monitoring tool(s) 20 of network 8-2 (sometimes generally referred to as end hosts or hosts 20). As examples, monitoring tools 20 may include one or more traffic service devices, one or more traffic analysis devices, one or more traffic monitoring devices, one or more network security devices, and/or one or more packet recorders for network traffic storage and/or network traffic metadata storage. If desired, controller 14 may also be communicatively coupled to and control the operations of one or more monitoring tools 20 via network or non-network paths to coordinate appropriate traffic monitoring operations.

Network devices 10 of network 8 (e.g., network devices 10-1 in network 8-1 and network devices 20-2 in network 8-2) may include any suitable number and/or types of network devices interconnected via corresponding port-to-port (or more generally interface-to-interface) connections. As examples, network devices 10 may include one or more switches (e.g., single-layer (Layer 2) switches and/or multi-layer (Layer 2 and Layer 3) switches), one or more bridges, one or more routers and/or gateways, one or more hubs, one or more repeaters, one or more firewalls, one or more wireless access points, one or more devices serving other networking functions, management equipment that manage and control the operation of one or more of these network devices (e.g., serving as a portion of controller 14), and one or more devices that include the functionality of two or more of these devices.

End hosts of network 8 (e.g., end hosts 12 of network 8-1 and end hosts 20 of network 8-2) may be implemented on host equipment. The host equipment may include laptops, cellular telephones, or other portable electronic devices, desktop computers, server equipment (e.g., server computing equipment housed in server racks), and/or other suitable types of specialized or general-purpose computing equipment each running one or more services and/or applications.

In some illustrative configurations described herein as an example, controller 14 may be implemented on server equipment (e.g., server hardware for blade servers, rack servers, and/or tower servers). The server equipment may include compute device(s) collectively forming processing circuitry 16 of controller 14 and may include storage device(s) collectively forming memory circuitry 18 of controller 14. Processing circuitry 16 (e.g., compute devices included therein) may include one or more processors or processing units based on central processing units (CPUs), based on graphics processing units (GPUs), based on microprocessors, based on general-purpose processors, based on host processors, based on microcontrollers, based on digital signal processors, based on programmable logic devices such as field programmable gate array (FPGA) devices, based on application specific system processors (ASSPs), based on application-specific integrated circuit (ASIC) processors, and/or based on other processor architectures. Memory circuitry 18 (e.g., storage devices included therein) may include volatile memory such as dynamic random-access memory, static random-access memory, etc., non-volatile memory such as hard-drive storage, solid-state storage, flash memory, etc., removable memory, and/or other types of memory circuitry.

More specifically, memory circuitry 18 may include one or more non-transitory (tangible) computer-readable storage media that store the operating system software and/or any other software code, sometimes referred to as program instructions, software, data, instructions, or code. Processing circuitry 16 may run (e.g., execute) an operating system and/or other software/firmware that is stored on memory circuitry 18 to perform the desired operations of controller 14 (e.g., the operations as described herein in connection with the generation and use of custom network device memory profiles for network traffic matching).

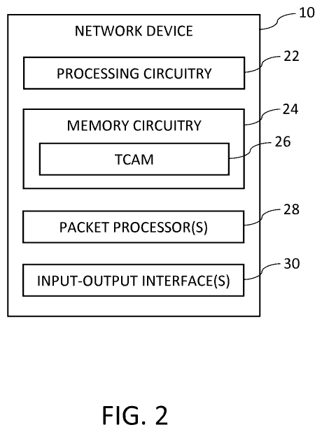

An illustrative implementation for a network device 10 of network 8 in FIG. 1 (e.g., one or more of network devices 10-1 and/or 10-2) is shown in FIG. 2. Configurations in which network device 10 of FIG. 2 implements network device(s) 10-2 in FIG. 1 are sometimes described herein as an illustrative example. Network device 10 may be a switch (e.g., a Layer 2 switch or a Layer 2 and Layer 3 switch), a router or gateway, a bridge, a hub, a repeater, a firewall, a wireless access point, a network management device that manages one or more other network devices, a device serving other networking functions, a device that includes a combination of these functions, or other types of network devices.

Network device 10 may include processing circuitry 22, memory circuitry 24, one or more packet processors 28, and input-output interfaces 30. In one illustrative arrangement, network device 10 may be or form part of a modular network device system (e.g., a modular switch system having removably coupled modules usable to flexibly adjust system capabilities such as adjust the network traffic processing capabilities by changing the number of processors, memory, and/or other hardware components, adjust the number of ports, add or remove specialized functionalities, etc.). In another illustrative arrangement, network device 20 may be a fixed-configuration network device (e.g., a fixed-configuration switch having a fixed number of ports and/or a fixed hardware configuration).

Processing circuitry 22 may include one or more processors or processing units based on central processing units (CPUs), based on graphics processing units (GPUs), based on microprocessors, based on general-purpose processors, based on host processors, based on microcontrollers, based on digital signal processors, based on programmable logic devices such as a field programmable gate array (FPGA) device, based on application specific system processors (ASSPs), based on application specific integrated circuit (ASIC) processors, and/or based on other processor architectures.

Processing circuitry 22 may run (e.g., execute) a network device operating system and/or other software/firmware that is stored on memory circuitry 24. Memory circuitry 24 may include one or more non-transitory (tangible) computer-readable storage media that stores the operating system software and/or any other software code, sometimes referred to as program instructions, software, data, instructions, or code. As an example, network device control plane functions may be stored as (software) instructions on the one or more non-transitory computer-readable storage media (e.g., in portion(s) of memory circuitry 24 in network device 10). The corresponding processing circuitry (e.g., one or more processors of processing circuitry 22 in network device 10) may process or execute the respective instructions to perform the corresponding operations. Memory circuitry 24 may be implemented using non-volatile memory (e.g., flash memory or other electrically-programmable read-only memory configured to form a solid-state drive, hard disk drive storage, etc.), volatile memory (e.g., static or dynamic random-access memory), and/or other storage circuitry. Processing circuitry 22 and (at least some portions of) memory circuitry 24 as described above may sometimes be referred to collectively as control circuitry (e.g., implementing a control plane of network device 10).

In particular, processing circuitry 22 may execute network device control plane software such as operating system software, routing policy management software, routing protocol agents or processes, routing information base agents, and other control software, may be used to support the operation of protocol clients and/or servers (e.g., to form some or all of a communications protocol stack such as the Transmission Control Protocol (TCP) and Internet Protocol (IP) stack), may be used to support the operation of packet processor(s) 28, may store packet forwarding information, may execute packet processing software, and/or may execute other software instructions that control the functions of network device 10 and the other components therein.

Packet processor(s) 28 may be used to implement a data plane or forwarding plane of network device 10. Packet processor(s) 28 may include one or more processors or processing units based on programmable logic devices such as field programmable gate array (FPGA) devices, based on application specific system processors (ASSPs), based on application specific integrated circuit (ASIC) processors, based on central processing units (CPUs), based on graphics processing units (GPUs), based on microprocessors, based on general-purpose processors, based on host processors, based on microcontrollers, based on digital signal processors, and/or based on other processor architectures.

Packet processor 28 may receive incoming data packets via input-output interfaces 30 (and/or via device internal interfaces), parse and analyze the received data packets, process the packets based on packet forwarding decision data (e.g., in a forwarding information base) and/or in accordance with network protocol(s) or other forwarding policy, and forward (or drop) the data packet accordingly. The packet forwarding decision data may be stored on memory circuitry integrated as part of or separate from packet processor 28 (e.g., a portion of memory circuitry 24).

To interact with external devices, external systems, and/or users, network device 10 may include input-output interfaces 30 formed from corresponding input-output devices (sometimes referred to as input-output circuitry or interface circuitry). Input-output interfaces 30 may include different types of communication interfaces such as Ethernet interfaces (e.g., formed from one or more Ethernet ports), optical interfaces (e.g., formed from removable optical modules containing optical transceivers), Bluetooth interfaces, Wi-Fi interfaces, and/or other network interfaces for connecting device 10 to the Internet, a local area network, a wide area network, a mobile network, generally network device(s) in these networks, and/or other computing equipment (e.g., end hosts, server equipment, user devices, etc.). As an example, some input-output interfaces 30 (e.g., those based on wireless communication) may be implemented using wireless communication circuitry (e.g., antennas, transceivers, radios, etc.).

As another example, some input-output interfaces 30 (e.g., those based on wired communication) may be implemented on physical ports. These physical ports may be configured to physically couple to and/or electrically connect to corresponding mating connectors of external components or equipment (e.g., cables, pluggable optical transceiver modules, etc.). Different ports may have different form-factors to accommodate different cables, different modules, different devices, or generally different external equipment.

A packet processor 28 may process received network traffic (e.g., production network traffic in network 8-1 in FIG. 1, mirrored network traffic in network 8-2 in FIG. 1, etc.) based on comparing header information in the network traffic to flow entries in memory (e.g., in a portion of memory circuitry 24). Each entry may specify one or more matching criteria based on different header fields and one or more actions to be taken for the matching network traffic (e.g., the network traffic whose header information matches or satisfies the one or more matching criteria).

To increase the speed at which network traffic is processed by packet processor 28 (e.g., the speed at which the corresponding flow entries are searched for a match by packet processor 28), the memory on which these flow entries is stored may be content addressable memory (CAM) (e.g., binary content addressable memory and/or ternary content addressable memory (TCAM)). Due to its ability to wildcard values (e.g., bits) and/or fields using a third (don't care) state, TCAMs may be more flexibly in identifying various flows of network traffic (e.g., network traffic can be matched on a subset of bits in a given header field, can be matched on some header fields while other header fields are wildcarded, etc.). Configurations in which network traffic matching is performed by comparing traffic header information to flow entries stored on a ternary content addressable memory (TCAM) such as TCAM 26 are sometimes described herein as an illustrative example. However, if desired, entries for network traffic matching may be stored in other types of memory circuitry in addition to or instead of TCAMs, depending on the desired type and/or speed of matching (e.g., if exact match is desired, if minimal speed requirements exist, etc.). Similarly, the generation and use of custom memory profiles to configure memory as described herein may be applicable to any suitable type of memory, including TCAMs and/or other types of memory circuitry (e.g., binary content addressable memory).

To define the qualifiers (e.g., header fields) based on which TCAM flow entries and their corresponding matching criteria are configured, the TCAM may be configured with a memory profile (e.g., a TCAM profile). The memory profile may specify a set of qualifiers (sometimes referred to as a set of memory resource types) each corresponding to a header field usable by one or more TCAM flow entries to specify a matching criterion at the header field. If desired, a portion of the qualifiers (instead of corresponding to header fields) may correspond to network device features provided using the TCAM profile such as Generic Routing Encapsulation (GRE) tunneling, Virtual Extensible Local Area Network (VXLAN) tunneling, VXLAN header stripping, etc., that share space with corresponding traffic header fields within the memory profile.

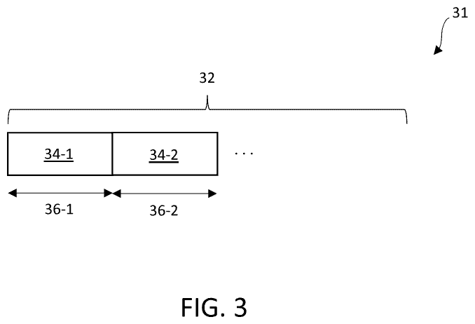

An illustrative memory profile 31 that may be used to configure a TCAM (or other types of memory) is shown in FIG. 3. In the example of FIG. 3, memory profile 31 may include a set of qualifiers 34, e.g., qualifiers 34-1, 34-2, etc. Each qualifier 34 may have an associated size 36 (e.g., may span a different amount of the total key space). Some qualifiers may have the same size and some qualifiers may have different sizes. In particular, a first qualifier 34-1 may have a first size 36-1 and a second qualifier 34-2 may have a second size 36-2. Sizes 36-1 and 36-2 may be the same or different (depending on the types of the respective qualifiers 34-1 and 34-2).

In some configurations, the qualifiers for a particular memory profile may include a predetermined combination of header fields (e.g., for implementing flow entries of common features or common policy rules). Illustrative header fields may include a source MAC (Media Access Control) address, a destination MAC address, a source IP label (corresponding to a source IPv4 (Internet Protocol version 4) or IPv6 (Internet Protocol version 4) address header field), a destination IP label (corresponding to a destination IPv4 or IPv6 address header field), an inner VLAN ID (virtual local area network identifier), an outer VLAN ID, encapsulation header fields (e.g., Generic Routing Encapsulation (GRE) header fields), user-defined or vendor-specified header fields, etc., as just a few examples. The size of each qualifier may be the number of bits occupied by the value of the qualifier or corresponding header field (e.g., a source or destination MAC address qualifier may have a size of 48 bits, a source or destination IPv4 address qualifier with a 16-bit mask may have a size of 16 bits associated with the variable bits, etc.)

Memory circuitry such as a TCAM may be configured with a memory profile of the type shown in FIG. 3. However, due to the limited size of the TCAM, the TCAM may have a limited size for a total key space (e.g., the space allocated to configured qualifiers). Accordingly, memory profile 31 for configuring the TCAM may similarly have a maximum size 32 for qualifiers. In other words, the sum of the sizes of all qualifiers in memory profile 31 (e.g., the sum of sizes 36-1, 36-2, etc.) should not exceed size 32. As examples, the maximum size 32 may be a size greater than 100 bits, greater than 200 bits, greater than 300 bits, etc., and/or may be a size less than 700 bits, less than 600 bits, less than 500 bits, less than 400 bits, etc.

Because of the limited space for qualifiers, not all possible qualifiers can be included in a single memory profile. However, to provide a given network device with the capability to match on most if not all supported qualifiers, different predetermined memory profiles each having a different set of qualifiers (e.g., a different subset of the supported qualifiers) may be stored on network device 10 (e.g., on a portion of memory circuitry 24 associated with the control plane of network device 10). The qualifier coverage afforded by the combination of qualifiers in the predetermined memory profiles may be sufficient to generally cover most if not all possible (supported) qualifiers. Upon network device startup and/or at any suitable time during device operation, processing circuitry 22 may configure memory (e.g., the TCAM) with a selected one of the predetermined memory profiles to facilitate the programming of the desired set of flow entries for network traffic matching.

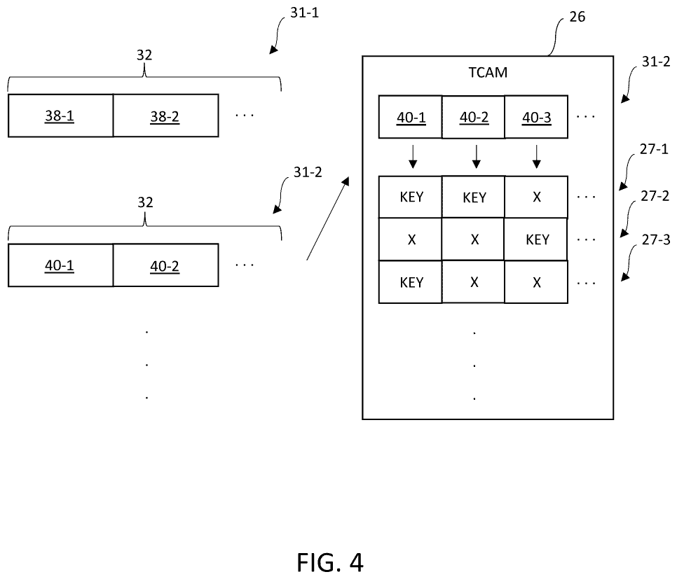

FIG. 4 is a diagram of illustrative memory circuitry, such as TCAM 26, configured with a predetermined and pre-stored memory profile. As shown in FIG. 4, network device 10 (e.g., memory circuitry 24) may store a set of predetermined set of memory profiles 31 (referring collectively to memory profiles 31-1, 31-2, and any other memory profiles) each having a respective set of qualifiers (e.g., qualifiers 38-1, 38-2, etc., for profile 31-1, qualifiers 40-1, 40-2, etc., for profile 31-2). Some qualifiers may be shared with or common across different memory profiles and/or some qualifiers may be unique to a given memory profile.

At a suitable time (e.g., during network device initialization), processing circuitry 22 (e.g., by executing software instructions stored on memory circuitry 24) may configure memory such as TCAM 26 with a given one of the predetermined memory profiles. In the example of FIG. 4, processing circuitry 22 may configure TCAM 26 with memory profile 31-2 and qualifiers 40 therein. Based on qualifiers 40 or more explicitly qualifiers 40-1, 40-2, 40-3, etc. in profile 31-2, TCAM 26 may store flow entries 27 based on the desired network policy to be implemented at network device 10. Each flow entry 27 may include a set of key (bit) values in key fields for matching header information of received network traffic and may identify one or more corresponding actions to be taken on matching network traffic.

Key fields for flow entries 27 may be based on qualifiers in the configured memory profile 31-2. As a few illustrative examples shown in FIG. 4, a first entry 27-1 may use at least qualifiers 40-1 and 40-2 (and other qualifiers in profile 31-2) as key fields for selectively matching values of corresponding header fields in the received network traffic and may use at least qualifier 40-3 (and other qualifiers in profile 31-2) as don't care or wildcarded field(s) that always match on the received network traffic, a second entry 27-2 may use at least qualifier 40-3 (and other qualifiers in profile 31-2) as key field(s) for selectively matching values of corresponding header field(s) in the network traffic and may use at least qualifiers 40-1 and 40-2 (and other qualifiers in profile 31-2) as don't care or wildcarded fields that always match on the received network traffic, a third entry 27-3 may use at least qualifier 40-1 (and other qualifiers in profile 31-2) as key field(s) for selectively matching values of corresponding header field(s) in the network traffic and may use at least qualifiers 40-2 and 40-3 (and other qualifiers in profile 31-2) as don't care or wildcarded fields that always match on the received traffic, etc.

Wildcarded fields will match on all values in the corresponding header fields in the received network traffic and are therefore non-selective. Key fields for each entry may contain key values for matching to specific values of the corresponding header fields in the network traffic, thereby providing the matching criteria for selecting network flows for flow entries 27. While the example of FIG. 4 shows entire fields as key fields or wildcarded fields, this is merely illustrative. If desired, one or more bits for a given field may be key bits for selective matching while one or more remaining bits for the given field may be wildcarded bits (that always match and are non-selective).

While the approach described in connection with FIG. 4 of using predetermined memory profiles may be satisfactory in some scenarios, this approach may be limiting as it is non-scalable. Consider an example in which user configurations (e.g., for implementing a network policy such as a traffic policy, an access control list policy, etc.) are optimally implemented when TCAM 26 stores flow entries is defined using qualifiers 40-1, 40-2, and 38-1, among other qualifiers. Because this optimal combination of qualifiers may not exist in any of the predetermined and pre-stored memory profiles 31 (FIG. 4), configuring TCAM 26 to include this combination of qualifiers using the approach described in connection with FIG. 4 may not be possible unless a new memory profile is constructed and stored. As demonstrated by this example, any non-existent combination of qualifiers would require a new memory profile. However, constructing, storing, and/or maintaining numerous predetermined memory profiles may be tedious and impractical. Furthermore, given the complexities associated with qualifier selection or generally memory profile configuration, it may be desirable to optimally implement network policy without necessarily exposing a user (e.g., a network administrator) to the details of qualifier selection and memory profile configuration.

Accordingly, rather than providing a set of fixed predetermined memory profiles to choose from, a system in which a customized memory profile is dynamically generated and used to configure memory for network traffic matching is described herein. Illustrative configurations in which a controller such as controller 14 (e.g., a controller server implemented as part of or separately from a management server) generates the customized memory profile for configuring the network device memory are sometimes described herein as an example. If desired, other entities (e.g., other network device management equipment, other types of servers, some network devices themselves, etc.) may instead perform the operations described herein in connection with controller 14 to generate the customized memory profile for configuring network device memory for network traffic matching.

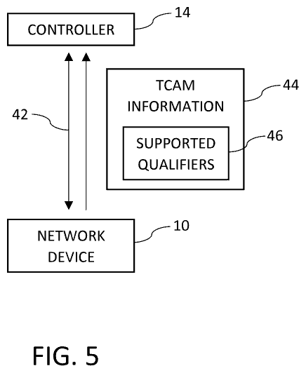

To facilitate the generation of a memory profile compatible with the corresponding memory (e.g., TCAM 26) on a network device for configuration, a controller may be configured to obtain information about the memory (e.g., support information indicating capabilities and/or settings supported by the memory). FIG. 5 is a diagram of an illustrative controller such as controller 14 configured to obtain information on network device memory such as TCAM information 44.

In the example of FIG. 5, controller 14 (e.g., processing circuitry 16 when executing software instructions stored on memory circuitry 18) and network device 10 (e.g., processing circuitry 22 when executing software instructions stored on memory circuitry 24) may exchange messages 42 to perform handshake operation or otherwise establish a connection for communication. These messages may be exchanged through network paths in network 8 (FIG. 1), e.g., through one or more intervening network devices 10, using the Internet and/or other server provider network(s), etc. As one illustrative example, messages 42 may be exchanged based on the OpenFlow specification to perform an initial handshake operation. If desired, other mechanisms or protocols may be used to facilitate communication between controller 14 and network device 10. Subsequent to establishing the connection for communication, network device 10 (e.g., processing circuitry 22 when executing software instructions stored on memory circuitry 24) may obtain and transmit, via interface(s) 30 (FIG. 2), information 44 about a TCAM (e.g., TCAM 26) that is configured to (when programmed) store flow entries (e.g., entries of the types described in connection with FIG. 4) used by packet processor(s) 28 to match and process received network traffic.

TCAM information 44 may generally include information about TCAM 26, and more specifically, may include support information for TCAM 26 indicative of the capabilities and/or settings supported by TCAM 26. In particular, TCAM information 44 may include qualifiers 46 supported by TCAM 26, supported by packet processors 28 when operating with TCAM 26, and/or supported by other relevant components (e.g., processing circuitry 22) of device 10 when operating with TCAM 26. TCAM information 44 may also include a maximum TCAM key space size (e.g., size 32 as described in connection with FIG. 3), types of packets handled by TCAM 26, and/or other contextual information about TCAM 26 (e.g., manufacturer information, memory constraints, memory interdependencies, etc.). Along with TCAM information 44, network device 10 (e.g., processing circuitry 22 when executing software instructions stored on memory circuitry 24) may also obtain and convey, to controller 14, contextual information about network device 10 (e.g., a type of network device 10, a functionality of network device 10, a relative location of network device 10 within network 8, etc.) and/or other information that may facilitate the customization of a memory profile and its qualifiers for TCAM 26 of the particular network device 10.

While the example of FIG. 5 shows a configuration in which TCAM information 44 or more generally network device information is received by controller 14 (e.g., processing circuitry 16) from network device 10, this is merely illustrative. If desired, controller 14 (e.g., processing circuitry 16 when executing software instructions stored on memory circuitry 18) may, alternatively or additionally, obtain all or some of this information via from other sources (e.g., based on received user input indicative of device and/or TCAM capabilities, from other network device management equipment that manages the operation of network device 10 and therefore stores information 44, etc.).

If desired, controller 14 may provide any of the obtained TCAM and/or network device information (e.g., information 44) to a user (e.g., to a computing device operated by a user). As an example, controller 14 may be communicatively coupled to the user computing device and provide, via a web application (e.g., in a scenario in which controller 14 is implemented using (web and/or application) server(s) for the web application), any of the obtained information to the computing device. The obtained information may then be presented to the user via a user interface provided at the computing device. As another example (e.g., in a scenario in which controller 14 is a discrete controller device or is implemented using a private server), the user computing device may access controller 14 (e.g., remotely access controller 14) and send commands to the controller (e.g., via a command line interface of the controller device) to prompt any of the obtained TCAM information to be provided to the user computing device for user presentation at the computing device.

In some instances, a user computing device may interact directly with (e.g., remotely access, issue commands to, receive output from, etc., without an intervening controller or a management platform provided by the controller) the network device (e.g., via a command line interface provided by the network device) to obtain any of the TCAM and/or network device information (e.g., information 44). The obtained information may be provided as output via the command line interface. In particular, in these instances, the network device may be configured to facilitate the generation of custom TCAM profiles and to obtain (e.g., receive and/or generate) custom TCAM profiles for configuring TCAM(s) 26 on network device 10 without necessarily involving a controller such as controller 14.

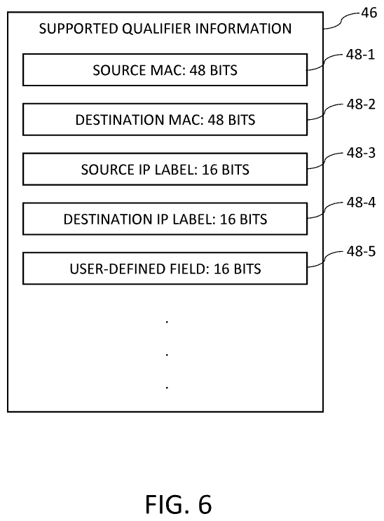

Some illustrative types of qualifiers and their information that may be used as part of qualifier information 46 transmitted by network device 10 and obtained (e.g., received) by controller 14 are shown in FIG. 6. In the example of FIG. 6, supported qualifier information 46 may generally include a type of qualifier and a size (e.g., a number of bits) of the qualifier. As shown in the example of FIG. 6, qualifier information 46 may identify a first qualifier entry 48-1 containing a source MAC address qualifier with a size of 48 bits, may identify a second qualifier entry 48-2 containing a destination MAC address qualifier with a size of 48 bits, may identify a third qualifier entry 48-3 containing a source IP (Internet Protocol) label (e.g., a source IP address) qualifier with a size of 16 bits (or another desired number of bits), may identify a fourth qualifier entry 48-4 containing a destination IP label (e.g., a destination IP address) qualifier with a size of 16 bits (or another desired number of bits), may identify a fifth qualifier entry 48-3 containing a user-defined field qualifier with a size of 16 bits (or another desired number of bits), etc.

These qualifier entries in supported qualifier information 46 of FIG. 6 are merely illustrative. As just a few more examples, other supported qualifiers may include qualifiers for an outer VLAN ID, an inner VLAN ID, an EtherType, a source L4 (Layer 4) port, a destination L4 port, TCP (Transmission Control Protocol) flags, an ICMP (Internet Control Message Protocol) code, an ICMP type, an IP protocol version, a DSCP (Differentiated Services Code Point) field, IP fragmentation flags, GRE or other encapsulation header fields, etc. Each qualifier of these supported qualifiers may similarly include a corresponding size (in bits). In general, appropriately supported qualifiers in qualifier information 46 may include any desired combination of qualifiers corresponding to header fields for matching (as afforded by network device and/or TCAM capability). Supported qualifier information 46 (and the qualifiers identified therein) may vary depending on the actual capabilities of the network devices (e.g., the TCAM therein) transmitting information 46 to controller 14. As such, some network devices 10 may convey the same set of supported qualifier information 46 to controller 14, while some network devices 10 may convey different supported qualifier information 46 to controller 14.

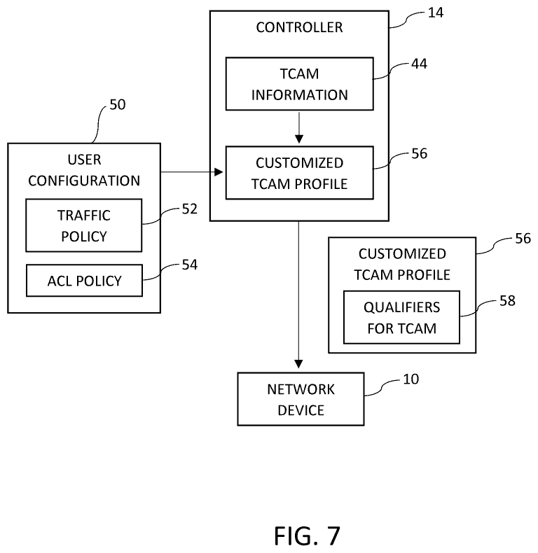

Based on the operations described in connection with FIG. 5, controller 14 (e.g., processing circuitry 16 when executing software instructions stored on memory circuitry 18) may have obtained (and stored) corresponding network device capability information (e.g., TCAM information 44 including supported qualifier information 46, a total TCAM key space size, etc.) and may use this information to generate a custom memory profile (containing a curated set of qualifiers) for the network device memory (e.g., the TCAM). FIG. 7 is a diagram of an illustrative controller such as controller 14 configured to generate the custom memory profile and an illustrative network device such as network device 10 configured to obtain the custom memory profile for configuring its TCAM 26.

As shown in FIG. 7, controller 14 (e.g., processing circuitry 16 when executing software instructions stored on memory circuitry 18) may store and maintain obtained TCAM information 44 on a portion of memory circuitry 18. Provided with TCAM information 44, controller 14 (e.g., processing circuitry 16) may be able to preferentially select a subset of supported qualifiers with which TCAM 26 on device 10 can be configured to facilitate the storage of flow entries for processing network traffic to implement a network policy (e.g., containing policy rules enforced by the flow entries).

In illustrative configurations sometimes described herein as an example, controller 14 (e.g., processing circuitry 16 when executing software instructions stored on memory circuitry 18) may obtain (e.g., receive) user configuration information 50 indicative of the network policy to be implemented. In particular, user configuration information 50 may be received as user input via a user interface (e.g., a command line interface) provided by controller 14, may be received via an application programming interface or other externally-facing interface, and/or may be received in the form of a configuration file. The network policy may include any combination of different types of policy rules having different functionalities such as rule(s) for traffic policy 52 (e.g., traffic policing), rule(s) ACL policy 54, rule(s) a sampling policy, rule(s) for a firewall policy, etc.

Generally, a network policy may be implemented by network device 10 processing different portions of network traffic (e.g., in different network flows) in different manners (e.g., using different actions). This type of processing behavior may be stored as flow entries in TCAM 26 (e.g., as flow entries of the type described in connection with entries 27 in FIG. 4). Accordingly, appropriate qualifiers should be selected by controller 14 (e.g., processing circuitry 16) to facilitate the programming of these flow entries.

In the example of FIG. 7, based on receiving user configuration information 50, controller 14 (e.g., processing circuitry 16 when executing software instructions stored on memory circuitry 18) may parse user configuration information 50 (e.g., specified policy rules) to obtain flow-defining information such as one or more header field types, lengths (in bits) of the header fields, and one or more values of the header fields. Corresponding actions may be taken for these network flows to implement the network policy (e.g., rules for the network policy).

As an illustrative example, based on user configuration information 50, controller 14 (e.g., processing circuitry 16 when executing software instructions stored on memory circuitry 18) may identify a first network flow to be network traffic having a first value at a first header field and a second value at a second header field, may identify a second network flow to be network traffic having a second value at the first header field and a first value at a third header field, and may identify a third network flow to be network traffic having a first value at a fourth header field. Accordingly, to match on these three network flows, TCAM 26 should be configured with flow entries having the four header fields as the key field(s) and wildcarded field(s), as appropriate, for their entries.

Controller 14 (e.g., processing circuitry 16 when executing software instructions stored on memory circuitry 18) may subsequently determine the qualifiers (e.g., for constructing custom TCAM profile 56) in order to implement the network policy indicated by user configuration by selecting qualifiers corresponding to the header fields needed to identify each of the network flows for implementing the network policy. In particular, controller 14 may select the qualifiers of custom TCAM profile 56 to comply with or otherwise based on TCAM information 44 (e.g., a total size of the selected qualifiers not exceeding a maximum size of the key space for TCAM 26). Continuing with the example above, controller 14 (e.g., processing circuitry 16 when executing software instructions stored on memory circuitry 18) may identify the four qualifiers corresponding to the four header fields. Based on TCAM information 44, controller 14 may determine the sizes (in bits) of each of the four qualifiers (e.g., using supported qualifier information of the type described in connection with FIG. 6) and may determine that the total size of the four qualifiers (and any additional qualifiers in custom TCAM profile 56) satisfies (e.g., does not exceed) the maximum size of the key space for TCAM 26.

In such a manner, controller 14 (e.g., processing circuitry 16 executing software instructions stored on memory circuitry 18) may generate TCAM profile 56 containing a set of qualifiers customized for the received user configuration information 50 while taking into account received TCAM information 44 to ensure that the generated TCAM profile 56 is implementable on TCAM 26. Controller 14 (e.g., processing circuitry 16 executing software instructions stored on memory circuitry 18) may subsequently transmit TCAM profile 56 and the customized set of qualifiers 58 and/or generally information indicative of the selected set of qualifiers 68 to network device 10.

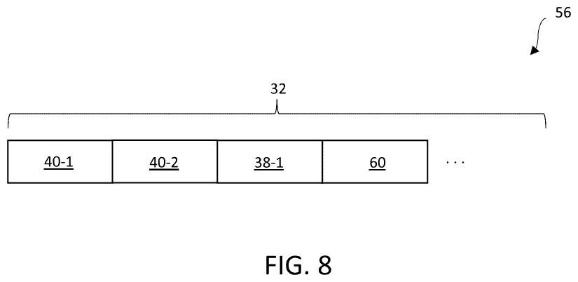

In particular, network device 10 (e.g., processing circuitry 22) may receive, via input-output interface(s) 30, one or more messages containing profile 56 and/or qualifiers 58 from controller 14. Network device 10 may obtain custom memory profile 56 for configuring TCAM 26 by processing the received message(s) to extract qualifiers 58. An illustrative custom or customized memory profile 56 (e.g., specific to user configuration information and TCAM information) is shown in FIG. 8. In the example of FIG. 8, custom memory profile 56 may include a first qualifier 40-1, a second qualifier 40-1, a third qualifier 38-1, and a fourth qualifier 60 (and any additional qualifiers). The total size of these qualifiers may be less than or equal to the maximum size of the key space (as determined by controller 18 based TCAM information 44).

Instead of configuring a TCAM with a selected predetermined or pre-stored memory profile (e.g., as described in connection with FIG. 4), network device 10 (e.g., processing circuitry 22 when executing software instructions stored on memory circuitry 24) may configure TCAM 26 with a received custom memory profile 56 dynamically generated by controller 14. In other words, instead of performing the configuration of TCAM 26 using a fixed pre-stored memory profile 31-2, network device 10 may configure TCAM 26 using custom memory profile 56. If desired, network device 10 may initially configure TCAM 26 with a pre-stored memory profile 31-2 and may subsequently update the configuration of TCAM 25 with custom memory profile 56, when received from controller 14.

In a similar manner to that described in connection with FIG. 4, network device 10 may configure TCAM with a memory profile (e.g., custom memory profile 56 instead of memory profile 31-2). More specifically, TCAM 26 may be configured with qualifiers 40-1, 40-2, 38-1, 60, etc. of memory profile 56 as shown in FIG. 8 in place of qualifiers 40-1, 40-2, 40-3, etc., of memory profile 31-2 as shown in FIG. 4. As such, the key fields and wildcarded fields of the flow entries (e.g., of the type described in connection with FIG. 4) may be defined based on qualifiers 40-1, 40-2, 38-1, 60, etc., of memory profile 56 instead of qualifiers 40-1, 40-2, 40-3, etc., of memory profile 31-2. These flow entries may in turn be programmed (e.g., after TCAM 26 is configured with profile 56) based on implementing policy rules for a network policy. Packet processor(s) 28 may subsequently process any received network traffic by matching on these flow entries having respective key fields defined by qualifiers of custom memory profile 56 and taking appropriate action(s) on matched network traffic (as indicated by the matched flow entry).

As demonstrated by the example of FIG. 8, qualifiers that may be part of different predetermined memory profiles (e.g., at least memory profiles 31-1 and 31-2 in FIG. 4) may be used to form a custom memory profile 56. In such manner, a custom memory profile 56 that is optimized for the needs of the user (e.g., optimized for a desired network policy) may be generated and used for programming flow entries for policy rules of the network policy, rather than having the user get by with fixed predetermined memory profiles that may be suboptimal in implementing flow entries for the policy rules.

In some instances, it may be not be possible to provide a custom memory profile for implementing policy rules indicated by user configuration information 50 in a manner supported by TCAM 26 (e.g., as indicated by any generated custom memory profile(s) not being compliant with TCAM information 44 or not supported by TCAM 26). In these instances, controller 14 (e.g., processing circuitry 16 when executing software instructions stored on memory circuitry 18) may determine that custom memory profile(s) generated based on user configuration information 50 (e.g., for implementing a combination of policy rules for a network policy) are not compliant with TCAM information 44. Accordingly, responsive to this determination, controller 14 (e.g., processing circuitry 16 when executing software instructions stored on memory circuitry 18) may provide an indication (e.g., as user output to a user device communicative coupled to controller 14) that a custom memory profile cannot be successfully generated and/or may provide output indicating the reason(s) for this (e.g., TCAM 26 and/or device 10 does not have the capabilities of processing certain types of traffic necessitated by user configuration information 50, the key space size of TCAM 26 will be exceeded, etc.). If desired, the controller may also output possible remediation actions (e.g., suggest an alternative network policy configuration that is implementable, suggest an alternative network device that at which the network policy configuration is implementable, etc.).

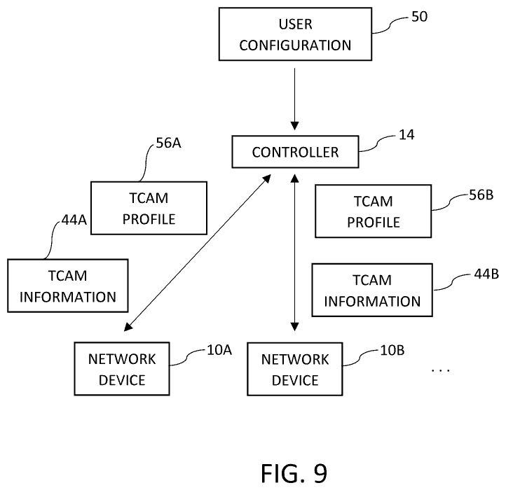

Because TCAM information and/or other network device contextual information used to generate custom profiles is obtained on a per-network-device basis, custom TCAM profiles may be generated for different network devices to implement the same network policy. FIG. 9 is a diagram of an illustrative controller such as controller 14 configured to provide custom TCAM profiles to multiple network devices to implement the same network policy (e.g., indicated by user configuration information 50).

In the example of FIG. 9, network devices 10A and 10B (and any additional network devices communicatively coupled to controller 14) may each be a different network device 10 in network 8. Network devices 10A and 10B may have the same or different capabilities (e.g., may have the same or different supported TCAM qualifier information, may have the same or different TCAM capabilities, may be same or different types of network devices, etc.) and/or may be located in different parts of network 8 (e.g., be different network devices 10-2 in network 8-2 in FIG. 1).

Each of network devices 10A and 10B may perform the operations described in connection with FIGS. 5-7 for network device 10. Accordingly, network device 10A may transmit TCAM information 44A (e.g., including qualifiers supported by a TCAM 26 of network device 10A, a maximum key space size of the TCAM 26 of network device 10A, etc.), while network device 10B may transmit TCAM information 44B (e.g., including qualifiers supported by a TCAM 26 of network device 10B, a maximum key space size of the TCAM 26 of network device 10B, etc.). Controller 14 may receive and store respective TCAM information 44A and 44B along with corresponding additional contextual information on the network devices (e.g., indicating their type, functionality, location within the network, etc.).

Controller 14 (e.g., processing circuitry 16 when executing software instructions stored on memory circuitry 18) may receive user configuration information 50 containing information for implementing a desired network policy (e.g., containing information indicative of policy rules for implementing the network policy). To implement the network policy, controller 14 (e.g., processing circuitry 16 when executing software instructions stored on memory circuitry 18) may generate TCAM profiles for respective TCAMs 26 on network devices 10A and 10B (and TCAMs on other network devices 10 as appropriate). In particular, controller 14 (e.g., processing circuitry 16 when executing software instructions stored on memory circuitry 18) may generate a custom memory profile (e.g., TCAM profile 56A) for TCAM 26 of network device 10A based on user configuration information 50 and TCAM information 44A and may generate a custom memory profile (e.g., TCAM profile 56B) for TCAM 26 of network device 10B based on user configuration information 50 and TCAM information 44B.

In some scenarios, TCAM profiles 56A and 56B may be the same. In other scenarios, TCAM profiles 56A and 56B may be different (e.g., include different combinations of qualifiers). In particular, controller 14 (e.g., processing circuitry 16 when executing software instructions stored on memory circuitry 18) may parse the received policy rules in the different contexts of the two network devices to obtain network-device-specific custom memory profiles for their respective TCAMs.

As an example, network devices 10A and 10B may be configured to support different types of TCAM qualifiers and/or may have different TCAM key space sizes (e.g., different maximum key space sizes). Accordingly, to generate custom profiles 56A and 56B that are respectively compliant with differing TCAM information 44A and 44B, controller 14 (e.g., processing circuitry 16 when executing software instructions stored on memory circuitry 18) may generate different TCAM profiles 56A and 56B with which respective TCAMs on devices 10A and 10B are configurable and based on which corresponding flow entries for implementing the policy rules can be stored.

As another example, network devices 10A and 10B may have the same (or different) TCAM information 44A and 44B but may be located in different portions of network 8 (e.g., serve different functions, e.g., one as a core network device and the other as an edge network device, one as an encapsulating and/or decapsulating network device and the other as an intervening transport network device, etc.). Accordingly, to generate custom profiles 56A and 56B that are that are suitable for implementing different portions of the network policy (based on the different locations and functions of devices 10A and 10B), controller 14 may generate different TCAM profiles 56A and 56B with which respective TCAMs on devices 10A and 10B are configurable and based on which corresponding flow entries for implementing the policy rules can be stored.

These examples are merely illustrative. In general, controller 14 (e.g., processing circuitry 16 when executing software instructions stored on memory circuitry 18) may parse user configuration information 50 and/or respective TCAM information to selectively provide memory profiles suitable for configuring the same and/or different entries to implement the same network policy at multiple network devices.

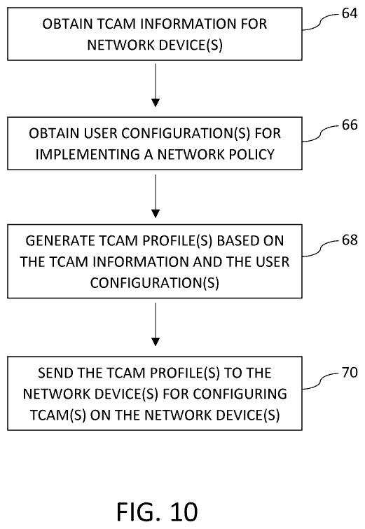

FIG. 10 is a flowchart of illustrative operations for configuring memory for network traffic matching with a custom memory profile. These operations described in connection with

FIG. 10 may be performed using controller 14 and network device(s) 10 of network 8 as described in connection with FIGS. 1, 2, and 5-9. The illustrative operations described in connection with FIG. 10 may generally be performed using respective processing circuitry on controller 14 and network device 10 (e.g., by executing, on the processing circuitry, software instructions stored on memory circuitry on server computing equipment and/or on the network device).

At block 64, one or more processors (e.g., for controller 14, for a controller server, for a management server, etc.) may obtain TCAM information for one or more network devices. As an example, the one or more processors may obtain TCAM information (e.g., a set of TCAM-supported qualifiers, a maximum size of TCAM key space, etc.) in a manner described in connection with FIGS. 5 and 6 and/or FIG. 9.

At block 66, the one or more processors may obtain user configuration information for implementing a network policy. As an example, the one or more processors may obtain user configuration information (e.g., indicative of policy rules for a network policy such as traffic policy rules and/or ACL policy rules) in a manner described in connection with FIG. 7 and/or FIG. 9.

At block 68, the one or more processors may generate TCAM profile(s) for the network devices(s) based on the TCAM information for the respective network device(s) and based on the user configuration information. As an example, the one or more processors may obtain (e.g., generate) custom TCAM profiles (e.g., each including a subset of supported qualifiers) in a manner described in connection with FIGS. 7 and 8 and/or FIG. 9.

At block 70, the one or more processors may send the generated TCAM profiles to the respective network device(s) for configuring corresponding TCAM(s) on the network device(s). As an example, the one or more processors may provide (e.g., send) the custom TCAM profiles (e.g., each including a subset of supported qualifiers) to corresponding network devices in a manner described in connection with FIGS. 7 and 8 and/or FIG. 9.

While illustrative configurations in which processing circuitry 16 on controller 14 (executing software instructions stored on memory circuitry 18) helps facilitate the generation of custom TCAM profiles for network device 10 are sometimes described herein as examples, these examples are merely illustrative. If desired, processing circuitry 22 of network device 10 (executing software instructions stored on memory circuitry 24) may obtain (e.g., generate) custom TCAM profiles for its local TCAM 26, with or without involving controller 14.

In some illustrative scenarios, processing circuitry 22 may provide a user interface (e.g., a command line interface, an application programming interface) through which user configuration(s) for implementing a network policy can be obtained (e.g., received). Processing circuitry 22 may obtain TCAM information for TCAM 26 (e.g., information 44 such as qualifiers supported by TCAM 26, a size of each supported qualifier, a total key space size of TCAM 26, etc.) and/or other information, and generate a custom TCAM profile based on the obtained information and the obtained network policy (as provided by the user configuration(s)). In other words, processing circuitry 22 may perform at least some, if not all, of the operations described in connection with blocks 64, 66, and 68 in FIG. 10 locally on network device 10 and may thereafter configure TCAM 26 based on the custom TCAM profile.

The methods and operations described above in connection with FIGS. 1-10 may be performed by the components of the network device(s) and/or server or other computing equipment (e.g., network devices 10, controller 14, etc.) using software, firmware, and/or hardware (e.g., dedicated circuitry or hardware). Software code for performing these operations may be stored on non-transitory computer-readable storage media (e.g., tangible computer-readable storage media) stored on one or more of the components of the network device(s) and/or server or other computing equipment. The software code may sometimes be referred to as software, data, instructions, program instructions, or code. The non-transitory computer-readable storage media may include drives, non-volatile memory such as non-volatile random-access memory (NVRAM), removable flash drives or other removable media, other types of random-access memory, etc. Software stored on the non-transitory computer-readable storage media may be executed by processing circuitry on the network device(s) and/or server or other computing equipment (e.g., processing circuitry 22 in FIG. 2, processing circuitry 16 in FIG. 1, etc.).

The foregoing is merely illustrative and various modifications can be made to the described embodiments. The foregoing embodiments may be implemented individually or in any combination.

What is claimed is:

1. A method of operating a controller in a system that includes a network device having a ternary content addressable memory (TCAM), the method comprising:
obtaining, by the controller, information about the TCAM;
receiving, by the controller, user configuration information indicative of a network policy at least partly implemented by the network device;
generating, by the controller, a memory profile for configuring the TCAM based on the information about the TCAM and based on the user configuration information, the memory profile including a set of qualifiers; and
providing, by the controller, the memory profile to the network device.

2. The method defined in claim 1, wherein the information about the TCAM comprises qualifiers supported by the TCAM.

3. The method defined in claim 2, wherein the information about the TCAM comprises a size of each of the qualifiers supported by the TCAM.

4. The method defined in claim 3, wherein the information about the TCAM comprises a total key space size of the TCAM.

5. The method defined in claim 2, wherein the qualifiers supported by the TCAM comprise a source Media Access Control (MAC) address, a destination MAC address, a source Internet Protocol (IP) address, a destination IP address, a source Layer 4 port, a destination Layer 4 port, an inner virtual local area network (VLAN) identifier, an outer VLAN identifier, one or more tunneling header fields, and one or more user-defined fields.

6. The method defined in claim 1, wherein the network policy comprises a policy rule, the method further comprising:
identifying, by the controller, a network flow associated with the policy rule;
determining traffic header fields for identifying the network flow; and
selecting the set of qualifiers based at least in part on the traffic header fields for identifying the network flow.

7. The method defined in claim 6, wherein the policy rule of the network policy comprises a traffic policy rule.

8. The method defined in claim 6, wherein the policy rule of the network policy comprises an access control list policy rule.

9. The method defined in claim 6, wherein the network policy comprises one or more additional policy rules, the method further comprising:
identifying, by the controller, one or more additional network flows associated with the one or more additional policy rules;
determining additional traffic header fields for identifying the one or more additional network flows; and
selecting the set of qualifiers based at least in part on the additional traffic header fields for identifying the one or more additional network flows.

10. The method defined in claim 9, wherein selecting the set of qualifiers comprises determining that the set of qualifiers is compatible with the information about the TCAM.

11. The method defined in claim 10, wherein compatibility of the set of qualifiers with the information about the TCAM is based on each qualifier in the set of qualifiers being supported by the TCAM as indicated by the information about the TCAM and is based on a total size of the set of qualifiers not exceeding a key space size indicated by the information about the TCAM.

12. The method defined in claim 1, wherein the network device is operable to configure the TCAM with the memory profile and to store, with the TCAM, flow entries having key fields based on the set of qualifiers of the memory profile.

13. The method defined in claim 1 further comprising:
obtaining, by the controller, information about an additional TCAM of an additional network device;
generating, by the controller, an additional memory profile for additional TCAM based on the information about the additional TCAM and based on the user configuration information; and
providing, by the controller, the additional memory profile to the additional network device.

14. The method defined in claim 13, wherein the additional memory profile includes an additional set of qualifiers different from the set of qualifiers in the memory profile.

15. A method of operating a network device having a ternary content addressable memory (TCAM) in a system that includes a controller, the method comprising:
transmitting, by the network device and to the controller, a set of qualifiers supported by the TCAM, a size of each qualifier in the set of qualifiers, and a total key space size of the TCAM;
receiving, by the network device and from the controller, a subset of qualifiers in the set of supported qualifiers, wherein the subset of qualifiers is based on one or more network policy rules provided by user configuration; and
configuring, by the network device, the TCAM based on the subset of qualifiers.

16. The method defined in claim 15, wherein the set of qualifiers supported by the TCAM, the size of each qualifier in the set of qualifiers, and the total key space size of the TCAM are transmitted as part of support information for the network device and wherein the subset of qualifiers is compatible with the support information for the network device.

17. The method defined in claim 15 further comprising:
storing one or more flow entries for the network policy rules, each flow entry identifying a network flow based on one or more header fields corresponding to one or more qualifiers in the subset of qualifiers.

18. The method defined in claim 17 further comprising:
receiving network traffic;
matching header information in the received network traffic to the one or more flow entries for the network policy rules; and
taking one or more corresponding actions based on the header information matching a given flow entry in the one or more flow entries.

19. One or more non-transitory computer-readable storage media comprising computer-executable instructions that, when executed by one or more processors, cause the one or more processors to:
obtain a set of qualifiers supported by a ternary content addressable memory (TCAM) of a network device, a size of each qualifier in the set of qualifiers, and a total key space size of the TCAM;
obtain one or more network policy rules provided by user configuration; and
provide a subset of qualifiers in the set of supported qualifiers based on the one or more network policy rules, the set of qualifiers, the size of each qualifier in the set of qualifiers, and the total key space size of the TCAM, wherein the subset of qualifiers is usable to configure the TCAM.

20. The one or more non-transitory computer-readable storage media defined in claim 19, wherein the subset of qualifiers identifies one or more header fields based on which a network flow corresponding to a flow entry in the one or more network policy rules is identified.
